(19) United States
(12) Patent Application Publication
(10) Pub. No.: US 2005/0169138 A1
(43) Pub. Date: Aug. 4, 2005

(54) Apparatus and method of performing pause motion of optical pickup

(75) Inventors: Jong-jin Lee, Seoul (KR); Kwan-ho Chun, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/974,785

(22) Filed: Oct. 28, 2004

(30) Foreign Application Priority Data
Feb. 2, 2004 (KR) 2004-6609

(51) Int. Cl. G11B 5/09

(52) U.S. Cl. 369/47.42; 369/47.11; 369/47.22

(57) ABSTRACT

An apparatus and method of performing a stable pause motion of an optical pickup over an optical disk which has both an occupied area and an unoccupied area. Start addresses and end addresses of occupied areas on the optical disk are stored. When the optical pickup is over an unoccupied area, a pause-on command to maintain a current location of the optical pickup is issued. The optical pickup is moved to an end address of an occupied area being the closest to an address where the optical pickup is placed at the moment when the pause-on command is issued. Accordingly, the optical pickup stably pauses over the optical disk having both an occupied area and an unoccupied area.

### CROSS-REFERENCE TO RELATED APPLICATIONS

This application claims the priority of Korean Patent Application No. 2004-6609, filed on Feb. 2, 2004, in the Korean Intellectual Property Office, the disclosure of which is incorporated herein in by reference.

### BACKGROUND OF THE INVENTION

1. Field of the Invention

The present invention relates to an apparatus and method of performing a stable pause motion of an optical pickup over an optical disk which has both an occupied area and an unoccupied area.

2. Description of the Related Art

A pause-on operation is a function of an optical pickup in an optical disk drive to maintain a current position over a disk. Optical disks used in the optical disk drive have spiral surface structures (i.e., tracks). Hence, when an optical pickup is located on a disk, it tends to move to an outer circumference of a track along a spiral surface structure. As a result, the optical pickup moves to an outermost circumference of the disk to deviate from a current location. Accordingly, the pause-on operation is a function of the optical pickup to maintain the current position over the disk without moving to the outermost circumference of the disk. More specifically, the pause-on operation includes a series of operations of the optical pickup to return to a predetermined pause address when the pickup is moved at least several tracks from the predetermined pause address.

In a conventional pause-on operation, the current position of the optical pickup is read and then the optical pickup is commanded to pause on the current position. However, when the optical disk drive deals with a disk having both an occupied area and an unoccupied area and should command the optical pickup to pause over the unoccupied area, the optical disk drive must know the current location (address) of the optical pickup.

Generally, the optical disk drive operates at a constant angle velocity (CAV) when the optical pickup is over an unoccupied area of the optical disk. To ascertain the current location of the optical pickup over the unoccupied area, the CAV of the optical disk drive must be converted into a constant linear velocity (CLV). However, the velocity conversion is impossible, because it requires resetting of the parameters necessary to operate the optical disk drive. In other words, when the optical pickup is commanded to pause over an unoccupied area of the optical disk, the optical disk drive cannot recognize the location of the optical pickup and may not properly perform further operations (e.g., a seek).

### SUMMARY OF THE INVENTION

Accordingly, it is an aspect of the present invention to provide a method and apparatus to perform a stable pause operation of an optical pickup over an optical disk having both an occupied area and an unoccupied area so that the optical pickup can be prevented from abnormally reading the occupied area due to a failure in reading the unoccupied area.

Additional aspects and/or advantages of the invention will be set forth in part in the description which follows and, in part, will be obvious from the description, or may be learned by practice of the invention.

The foregoing and/or other aspects are achieved by providing a method of performing a pause-on operation of an optical pickup, the method including: storing start addresses and end addresses of occupied areas on an optical disk including the occupied areas and unoccupied areas; issuing a pause-on command to maintain a current location of the optical pickup when the optical pickup is over one of the unoccupied areas; and moving the optical pickup to the respective end address of the respective occupied area being closest to a current address of the optical pickup when the pause-on command is issued.

When the optical pickup performs reproduction or other commands after storing the start addresses and end addresses of the occupied areas, a current address of the optical pickup is read. Also, the occupied areas over which the optical pickup is located are stored.

In the operation of moving the optical pickup, the optical pickup is moved to an address which is obtained by subtracting the number of tracks and a predetermined offset value, which are necessary to execute the pause-on command, from an end address of an occupied area closest to the current address of the optical pickup.

The foregoing and/or other aspects are also achieved by providing an apparatus to perform a pause-on operation of an optical pickup, the apparatus including a spindle motor, a sled motor, and a controller. The spindle motor rotates an optical disk having both occupied areas and unoccupied areas. The sled motor moves the optical pickup, which reads data from the optical disk in response to a predetermined command. The controller stores start addresses and end addresses of the occupied areas, issues a pause-on command to maintain a current location of the optical pickup when the optical pickup is over an unoccupied area, and controls the spindle motor and the sled motor to move the optical pickup to an end address of an occupied area which is closest to an address where the optical pickup is placed at the moment when the pause-on command is issued.

The controller further includes a memory to store the start addresses and end addresses of the occupied areas.

When the optical pickup performs reproduction or other commands, the controller reads a current address of the optical pickup and stores in the memory the occupied areas over which the optical pickup is placed.

The controller moves the optical pickup to an address which is obtained by subtracting the number of tracks and a predetermined offset value, which are necessary to execute the pause-on command, from an end address of an occupied area closest to the current address of the optical pickup.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a structure of an apparatus to perform a pause-on operation of an optical pickup, according to an embodiment of the present invention;

FIG. 2 illustrates a disk to explain the pause-on operation of the optical pickup of FIG. 1; and

FIG. 3 is a flowchart illustrating a method of performing a pause-on operation of the optical pickup of FIG. 1.

### DETAILED DESCRIPTION OF THE PREFERRED EMBODIMENTS

Reference will now be made in detail to the embodiment of the present invention, an example of which is illustrated in the accompanying drawings, wherein like reference numerals refer to the like elements throughout. The embodiments are described below to explain the present invention by referring to the figures.

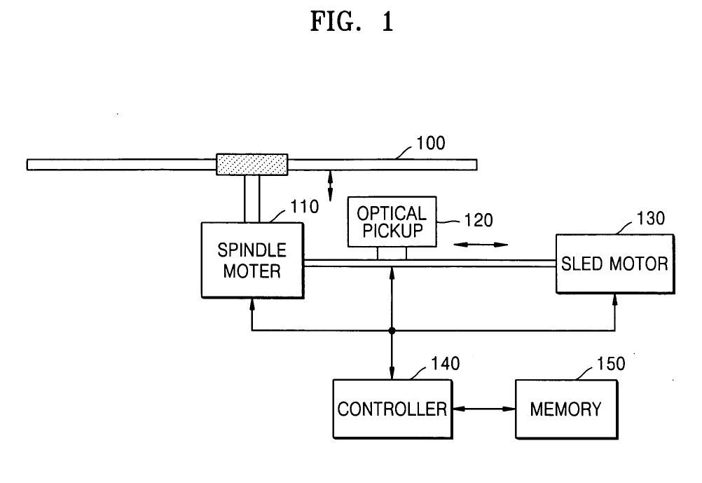

FIG. 1 is a block diagram of a structure of an apparatus to perform a pause-on operation of an optical pickup, according to an embodiment of the present invention. The apparatus includes an optical disk 100, a spindle motor 110, an optical pickup 120, a sled motor 130, a controller 140, and a memory 150.

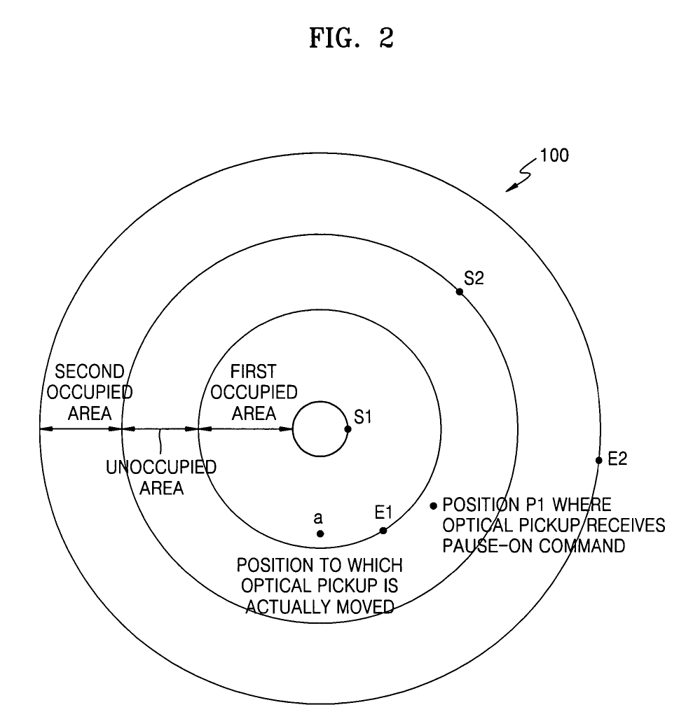

FIG. 2 illustrates the optical disk 100 to explain the pause-on operation of an optical pickup.

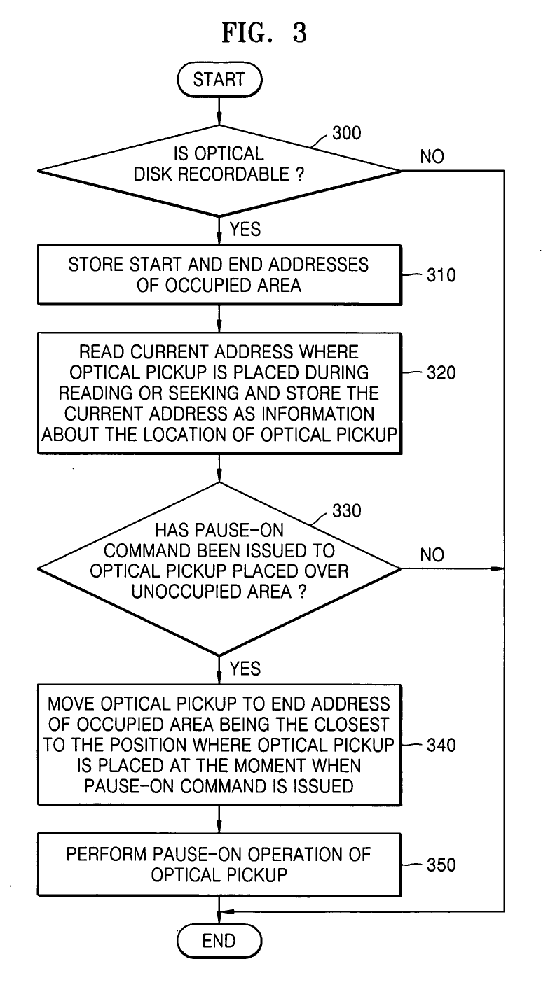

FIG. 3 is a flowchart illustrating a method of performing the pause-on operation of the optical pickup 120, according to the embodiment of the present invention. The method includes determining whether the loaded disk 100 is recordable (operation 300), storing the start and end addresses of an occupied area (operation 310), and reading a current address where the optical pickup 120 is placed during a read or a seek and storing the current address as information about the location of the optical pickup 120 (operation 320). The method further includes determining whether the pause-on command has been issued to the optical pickup 120 that is placed on an unoccupied area of the disk 100 (operation 330), moving the optical pickup to an end address of an occupied area being closest to the optical pickup 120 (operation 340), and pausing on the optical pickup (operation 350).

The apparatus to perform the pause-on operation of the optical pickup 120 will now be described in greater detail with reference to FIG. 1. Various recording methods have been developed for optical disks. Hence, the capability of coping with the partially occupied optical disk 100 has become important for the apparatus to perform a pause-on operation of the optical pickup 120. The recordable optical disk 100 of FIG. 2 is made up of first and second occupied areas and an unoccupied area.

The spindle motor 110 rotates the optical disk 100 under the control of the controller 140. The optical pickup 120 moves over the optical disk 100 under the control of the controller 140 and performs a command issued by the controller 140, for example, reads data from the optical disk 100. The sled motor 130 moves the optical pickup 120 under the control of the controller 140. A stepping motor may be used as the sled motor 130 and enables the optical pickup 120 to make a digital motion. The controller 140 stores the start and end addresses of the occupied areas on the optical disk 100 in the memory 150. The memory 150 may be installed inside or outside the controller 140.

When the optical pickup 120 moves to an unoccupied area over the optical disk 100, the controller 140 produces a pause-on command to maintain the optical pickup 120 in a current location, and controls the spindle motor 110 and the sled motor 130 to move the optical pickup 120 to the end address of the occupied area which is closest to the address when the pause-on command is issued.

At this time, the controller 140 reads a current location where the optical pickup 120 is placed during reproduction or other operations, and stores in the memory 150 the occupied areas over which the optical pickup 120 is located. Similarly, if the optical pickup 120 is located over an unoccupied area, the current location would be stored and read.

Referring to FIG. 2, first, the controller 140 stores the start address (S1) and end address (E1) of the first occupied area and the start address (S2) and end address (E2) of the second occupied area in the memory 150.

Thereafter, if the optical pickup 120 is moved to a position P1 in the unoccupied area on the optical disk 100 due to a reading operation or other operations, the controller 140 recognizes that the optical pickup 120 is positioned at a location between the first and second occupied areas.

The controller 140 issues a pause-on command to the optical pickup 120 when the optical pickup 120 is placed at the position P1. Then, theoretically, the controller 140 may operate the spindle motor 110 and the sled motor 130 so that the optical pickup 120 is moved to the end address (i.e., E1) of the occupied area being closest to the address (i.e., P1) where the optical pickup 120 is placed at the moment when the pause-on command has been issued.

Alternately, the controller 140 may move the optical pickup 120 to an address “a”, which is obtained by subtracting the number of tracks and a predetermined offset value, which is necessary to execute the pause-on command, from the end address E1 of the first occupied area. Since the optical disk 100 is spiral, and the optical pickup 120 continuously moves toward the outer boundary of the optical disk 100, if the optical pickup 120 is moved to the end address E1 of the first occupied area, the optical pickup 120 is highly likely to be moved back to the unoccupied area. Hence, the controller 140 controls the spindle motor 110 and the sled motor 130 to move the optical pickup 120 to the address “a” instead of the end address E1 of the first occupied area.

A method of performing the pause-on operation of the optical pickup 120, according to the embodiment of the present invention, will now be described with reference to FIGS. 2 and 3. First, in operation 300, the controller 140 determines whether the optical disk 100 is a recordable disk, that is, a disk having both an occupied area and an unoccupied area.

In operation 310, if the optical disk 100 is a recordable disk, the sled motor 130 stores the start and end addresses of the occupied area in the memory 150. Referring to FIG. 2, the controller 140 stores the start address (S1) and the end address (E1) of the first occupied area and the start address (S2) and the end address (E2) of the second occupied area in the memory 150.

In operation 320, the controller 140 reads a current address where the optical pickup 120 is placed during reading or seeking, and stores the current address as information about the location of the optical pickup 120. In other words, the controller 140 reads a current location where the optical pickup 120 is placed during reproduction or other operations and stores in the memory 150 which one of the occupied areas the optical pickup 120 is placed over.

Thereafter, in operation 330, the optical pickup 120 is moved to the position P1 over the unoccupied area, and at this time, the controller 140 issues the pause-on command to the optical pickup 120.

In operation 340, the controller 140 operates the spindle motor 110 and the sled motor 130 to move the optical pickup 120 to the end address (i.e., E1) of an occupied area being the closest to an address where the optical pickup 130 is placed at the moment when the pause-on command is issued.

In operation 350, the optical pickup 120 pauses on the end address (i.e., E1) of an occupied area being closest to the address where the optical pickup 120 is placed at the moment when the pause-on command has been issued. At this time, the controller 140 moves the optical pickup 120 to the address “a”, which is obtained by subtracting the number of tracks and a predetermined offset value, which are necessary to execute the pause-on command, from the end address E1 of the first occupied area. Since the optical disk 100 is spiral, and the optical pickup 120 continuously moves toward the outer boundary of the optical disk 100, if the optical pickup 120 is moved to the end address E1 of the first occupied area, the optical pickup 120 is highly likely to be moved back to the unoccupied area. Hence, the controller 140 controls the spindle motor 110 and the sled motor 130 to move the optical pickup 120 to the address “a” instead of the end address E1 of the first occupied area.

As described above, in the embodiment of the present invention, an optical pickup can stably pause over an optical disk having both an occupied area and an unoccupied area so that the optical pickup can be prevented from abnormally reading the occupied area due to a failure in reading the unoccupied area.

Although an embodiment of the present invention has been shown and described, it would be appreciated by those skilled in the art that changes may be made in this embodiment without departing from the principles and spirit of the invention, the scope of which is defined in the claims and their equivalents.

1. A method of performing a pause-on operation of an optical pickup, the method comprising:
storing start addresses and end addresses of occupied areas on an optical disk, the disk comprising the occupied areas and unoccupied areas;
issuing a pause-on command to maintain a current location of the optical pickup when the optical pickup is over one of the unoccupied areas; and
moving the optical pickup to the respective end address of the respective occupied area being closest to a current address of the optical pickup when issuing the pause-on command.

2. The method of claim 1, further comprising:
reading a current address of the optical pickup; and
storing the respective occupied area over which the optical pickup is located,
wherein the reading of the current address and the storing of the occupied area are performed after the storing of the start addresses and the end addresses of the occupied areas, when the optical pickup performs reproduction or other commands.

3. The method of claim 1, wherein the moving of the optical pickup comprises:
subtracting a number of tracks of the optical disk and a predetermined offset value, which are necessary to execute the pause-on command, from the respective end address of the respective occupied area closest to the current address of the optical pickup; and
moving the optical pickup to the respective end address corresponding to the subtracting.

4. An apparatus to perform a pause-on operation of an optical pickup, the apparatus comprising:
a spindle motor to rotate the optical disk, the optical disk comprising occupied areas and unoccupied areas;
a sled motor to move the optical pickup, which reads data from the optical disk in response to a command; and
a controller to store start addresses and end addresses of the occupied areas, issue a pause-on command to maintain a current location of the optical pickup when the optical pickup is over one of the unoccupied areas, and to control the spindle motor and the sled motor to move the optical pickup to the respective end address of the occupied area being the closest to a current address of the optical pickup when the pause-on command is issued.

5. The apparatus of claim 4, wherein the controller comprises a memory to store the start addresses and end addresses of the occupied areas.

6. The apparatus of claim 5, wherein when the optical pickup performs reproduction, the controller reads the current address of the optical pickup and stores the occupied areas over which the optical pickup is located in the memory.

7. The apparatus of claim 4, wherein the controller moves the optical pickup to an address which is obtained by subtracting a number of tracks of the optical disk and a predetermined offset value which is necessary to execute the pause-on command, from the respective end address of the occupied area closest to the current address of the optical pickup.

8. The method of claim 1, further comprising:
determining whether the issuing of the pause-on command occurs when the current location of the optical pickup is over one of the unoccupied areas.

9. The method of claim 1, wherein the disk comprises a plurality of tracks arranged in a spiral shape.

10. The method of claim 9, further comprising:
continuously moving the pickup towards an outer boundary of the disk during a recording operation of the optical pickup.

11. A method comprising:
issuing a pause-on command to maintain a current location of a pickup over an unoccupied area of a disk, the disk comprising the unoccupied area and first and second occupied areas; and
moving the pickup to an end address of the respective occupied area of the disk being closest to the current location of the pickup.

12. The method of claim 11, further comprising:
storing respective start addresses and end addresses of the occupied areas.

13. The method of claim 11, further comprising:
recording information to the disk, comprising moving the pickup from the first occupied area to the second occupied area via the unoccupied area.

14. The method of claim 11, further comprising:
reproducing information from the disk, comprising moving the pickup from the first occupied area to the second occupied area via the unoccupied area.

15. A method comprising:
issuing a pause-on command to maintain a current location of a pickup over an unoccupied area of a disk; and
recognizing a location of the pickup at a time of the issuing of the pause-on command.

16. An apparatus to operate on an optical disk comprising an unoccupied area and first and second occupied areas, comprising:
a pickup; and
a controller to issue a command to maintain a current location of the pickup over the disk when the pickup is over the unoccupied area, and to move the pickup to an end address of the occupied area being the closest to the current location of the pickup when the command is issued.

17. The apparatus of claim 16, further comprising:
a sled motor to move the pickup; and
a spindle motor to rotate the optical disk, the sled motor and the spindle motor moving the pickup to the closest end address.

18. An apparatus comprising:
an optical disk comprising an unoccupied area and first and second occupied areas;
a pickup to reproduce/record information from/to the optical disk; and
a controller to issue a command to maintain a current location of the pickup over the disk when the pickup is over the unoccupied area, and to move the pickup to an end address of the occupied area being the closest to the current location of the pickup when the command is issued.
